(19) United States
(12) Patent Application Publication
(10) Pub. No.: US 2010/0202878 A1
(43) Pub. Date: Aug. 12, 2010

(54) Turbo Engine and Method for Producing Such a Turbo Engine

(75) Inventors: Christian Wacker, Berlin (DE); Wojciech Murzyn, Berlin (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Turbo AG, Oberhausen (DE)

(21) Appl. No.: 12/677,024

(22) PCT Filed: Aug. 14, 2008
(86) PCT No.: PCT/EP08/06701

§ 371 Date: Mar. 8, 2010

(30) Foreign Application Priority Data
Sep. 7, 2007 (DE) 10 2007 042 529.7

(51) Int. Cl. F04D 29/54; B23P 15/00

(52) U.S. Cl. 415/208.1; 29/888.02

(57) ABSTRACT

A flow machine having a housing, an axial diffuser, a rotor for deflecting a fluid between an axial direction and a radial direction, a spiral, and an axial diffuser insert which is at least partially received in the housing. A spiral contour is formed in the diffuser insert and, together with the housing, defines the spiral.

### PRIORITY CLAIM

This is a U.S. national stage of application No. PCT/EP2008/006701, filed on Aug. 14, 2008, which claims Priority to the German Application No: 10 2007 042 529.7, filed: Sep. 7, 2007; the contents of both which are incorporated here by reference.

### BACKGROUND OF THE INVENTION

1. Field of the Invention

The present invention is directed to a flow machine with an overhung rotor, particularly a radial compressor or scroll compressor, a radial expander or scroll expander, a Francis turbine, or a radial pump, centrifugal pump, or scroll casing pump, and to a method for producing a flow machine of this kind.

2. Prior Art

In a flow machine of the generic type, a rotor is arranged between an axial diffuser and a spiral or a collecting chamber that deflects a fluid between an axial direction and a radial direction. For example, a rotor can be rotated by a driven rotor shaft and thereby draws fluid in the axial direction through the diffuser and diverts this fluid into the spiral or collecting chamber. As a result of the change in direction and the adjoining spiral or collecting chamber, the flow velocity of the fluid is converted into pressure so that a flow machine of this kind can, for example, compress gases as a compressor or can convey liquids as a pump.

Conversely, fluid flowing into the spiral or collecting chamber and exiting from the axial diffuser accompanied by a deflection of its flow direction obtains an angular momentum which it partially imparts to the rotor when passing through the latter so that the rotor drives a rotor shaft connected to the rotor accompanied by a reduction in flow energy or pressure energy. For example, a radial expander, by reducing pressure energy of a gas, or a Francis turbine, by reducing flow energy of a liquid, can be used to generate energy. These two possible uses can also be combined. For example, a first generic flow machine in the form of an expander can be driven by the exhaust gases of an internal combustion engine. A rotor of a second flow machine connected to the rotor of the first flow machine can then compress fresh air and feed it to the internal combustion engine. Therefore, in particular, a generic flow machine can form an expander and/or a compressor of a turbocharger of a, preferably self-igniting, internal combustion engine.

Spirals and other collecting chambers are uniformly designated as spirals in the following, but may also have other geometries. Accordingly, the term spiral contour is also meant generally as different collecting chamber contours which are not spiral shaped. In so far, the term “spiral” or “volute” can always be substituted with “collecting chamber”.

Up to the present time, spirals have been cast as cast housings receiving the rotor and a diffuser insert. This makes it possible to produce the spiral geometry in a material-saving manner as a free-form surface. However, it is disadvantageous that this mode of production requires expendable or non-expendable casting patterns. Therefore, in order to limit the quantity of casting patterns required, flow machines of this type are only manufactured in few different sizes. However, flow machines of this kind which can be chosen from a limited range are not optimally suited to the respective fluid flows and different rotor diameters. Also, this procedure still requires the production and stocking of a relatively large number of different casting patterns because, particularly for spirals having the same diameter but opposite running directions, two casting patterns must be kept on hand for the same diameter.

Generic flow machines have been tested in which the spiral contour is milled into a spiral flange that is butt-welded to a rear wall. A pressure connection piece is welded to the spiral flange that communicates with the spiral and is provided for the entrance and exit of the fluid

It is advantageous that different casting patterns need not be stocked for flow machines of the kind mentioned above. Further, the milled spirals can be optimized for the respective rotor or fluid flow. The semi-finished products comprising the spiral flange, rear wall and pressure connection piece can be produced from bar forging material that is easy to produce and stock.

However, it is disadvantageous that welds are required between the spiral flange, rear wall, and pressure connection piece. On the one hand, producing them is time-consuming and cost-intensive. On the other hand, the necessary fluid-tight and pressure-tight welds require a relative high weld quality, which further increases production cost. Also, only weldable semi-finished products can be used, which in particular complicates the simple, advantageous production of semi-finished products as a primary shaped part, e.g., a cast part, possibly with subsequent cutting machining. Therefore, flow machines of this type with a welded spiral flange in which the spiral contour is milled have so far been tested only for small structural sizes with correspondingly small fluid flows and fluid pressures.

### SUMMARY OF THE INVENTION

Therefore, an object of the present invention is to simplify the manufacture of a flow machine of the generic type.

A flow machine according to one embodiment of the invention comprises a housing, a rotor received therein, a spiral or a collecting chamber, and an axial diffuser insert which is received at least partially in the housing. A spiral contour is formed in the diffuser insert and, together with the housing, defines the spiral.

Therefore, in contrast to the known prior art, the spiral contour is not formed in the housing which consequently can be produced in a simple manner.

The spiral contour is preferably formed at a front surface and/or circumferential surface of the diffuser insert, which likewise simplifies the production of the diffuser insert provided with the spiral contour.

Due to the fact that the axial diffuser insert is received at least partially in the housing, fastening of the axial diffuser and sealing between the diffuser insert and housing are simplified. Accordingly, the diffuser insert can preferably be detachably connected to the housing, particularly by one or more screws. Accordingly, the above-mentioned disadvantages of the welded flow machine, i.e., the time-consuming and cost-intensive production of weld connections, are overcome. An additional advantage is that the flow machine can be assembled and dismantled repeatedly so that, for example, seals between the housing and diffuser insert or between the housing and rotor are more easily accessible. Further, damaged parts can easily be replaced and the rest of the parts of the flow machine can be reused, which reduces the cost of upkeep.

The spiral contour can preferably be formed in the diffuser insert by cutting, for example, in that it is milled into a front surface and/or circumferential surface of the diffuser insert.

The diffuser insert can also be formed as a primary shaped part, particularly as a cast part. The spiral contour is then formed by a corresponding casting pattern. In particular when the diffuser insert and housing are connected, to one another by a non-destructively detachable and reconnectable connection, i.e., a screw or other threaded connector, the diffuser insert and/or housing can be formed as a cast part because they must have good welding properties.

The diffuser insert and/or the housing can also be formed as a shaped part, particularly as a forged part, for example, a die-forged part. This makes possible a simple production and can contribute to greater strength of the flow machine according to the invention because of the compression of material taking place during forging.

Finally, the diffuser insert and/or housing can also be formed as a welded part. In contrast to the flow machine mentioned above which is known in-house, in which a spiral flange is butt-welded to a rear wall, diffuser inserts or housings formed as welded parts require shorter welds which can therefore be carried out in a time-saving, cost-saving manner.

When the spiral contour is formed in the diffuser insert by cutting or when the diffuser insert is formed as a welded part, the spiral geometry can always be optimally adapted to the rotor or to the fluid flow without having to stock a large number of casting patterns for this purpose.

The constructions mentioned above can also be combined. Accordingly, a diffuser insert formed as a shaped part, primary cast part or welded part can be connected to a housing formed as a shaped part, primary cast part or welded part.

In a preferred construction of the present invention, the housing is substantially pot-shaped and is connected in a fluid-tight manner to the diffuser insert. For this purpose, the diffuser insert can have a corresponding flange. This flange can be screwed to the housing, for example. A solid or fluid seal can preferably be provided between the flange and housing for this purpose.

When the diffuser insert forms a connection of the flow machine on the front side and extends to the rotor, the diffuser may be formed by the diffuser insert by itself. Alternatively, the diffuser insert can also form the diffuser together with the housing connected to it. Also, the diffuser insert can receive an inlet insert which then defines the diffuser by itself or together with the housing and/or diffuser insert. In the first and third cases, different diffuser geometries can advantageously be arranged in the same housing; in the second case, the diffuser insert can be shorter.

An orifice, particularly in the form of a pressure connection piece, for the entrance and exit of fluid which communicates with the spiral can be realized in a particularly simple manner by a bore hole in the housing. For this purpose, a corresponding bore hole which opens into a surface of the housing can lead to a receiving space for the diffuser insert which, together with the spiral contour formed in the diffuser insert, defines the spiral of the flow machine.

Guide vanes, for example, inlet guide vanes for deflecting the flow to the rotor or discharge guide vanes for converting flow velocity into pressure energy, are preferably provided in generic flow machines. In a flow machine according to one embodiment of the invention, a bearing can be formed in the housing, the diffuser insert and/or an inlet insert for guide vanes of this kind. A very compact structural shape is made possible in this way. Further, corresponding guide vanes can be secured to the flow machine so as to be particularly stationary and low in vibrations.

The rotor is fixedly or detachably connected to a rotor shaft. A sealed bearing can be formed in the housing for a rotor shaft of this kind. In a preferred construction, supply passages can also be formed in the housing for a shaft seal of this kind through which, for example, air, oil or another fluid can be fed to the shaft seal or removed from it.

### BRIEF DESCRIPTION OF DRAWINGS

Further solutions, advantages and features are indicated in the subclaims and the following embodiment examples. In the partially schematic drawings:

FIG. 1 is a sectional view of a flow machine according one embodiment of the present invention;

FIG. 2 is a perspective view in partial section of a diffuser insert of the flow machine according to FIG. 1, which diffuser insert is connected to a housing; and

FIG. 3 is a perspective view of the diffuser insert according to FIG. 2.

### DETAILED DESCRIPTION OF THE DRAWINGS

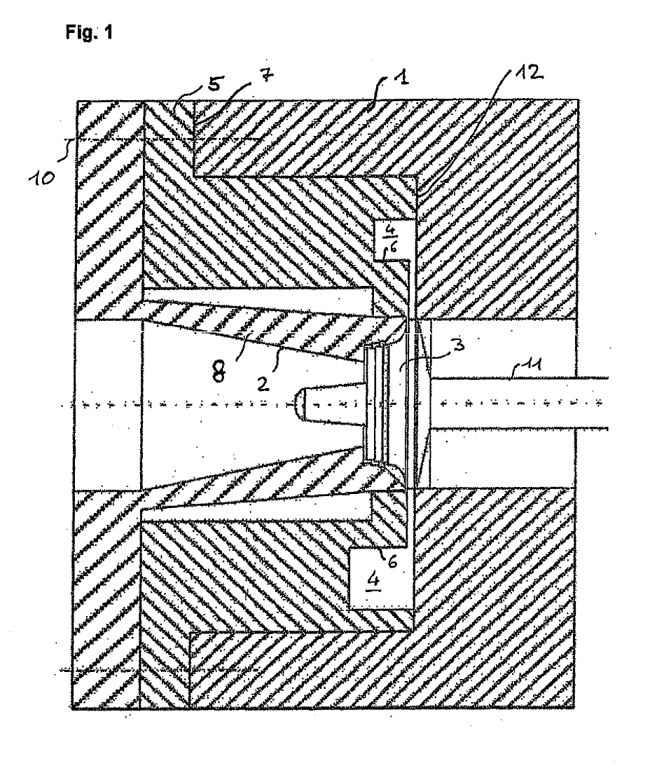

FIG. 1 is a sectional view of a flow machine according to a construction of the present invention in the form of a compressor. A rotor 3 is rotatably received in a cast, pot-shaped housing 1. An axial diffuser insert 5 is removably connected by screws 10 to the housing 1 via a flange 7. Together with the diffuser insert 5, an inlet insert 8 is also attached to the housing 1, preferably with the screws 10.

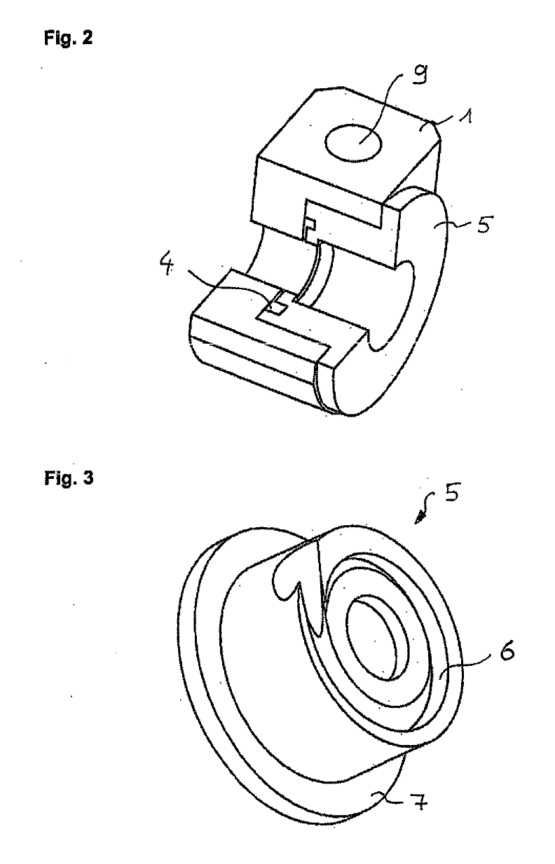

The inlet insert 8 forms an axial diffuser 2 in the form of a nozzle ring for axially guiding fresh air to the rotor 3 of the compressor. Rotor shaft 11 is driven by a turbine of a turbocharger (not shown) and rotates the rotor 3 which accordingly draws fresh air through the axial diffuser 2 and deflects it radially into a spiral 4. The fresh air is accordingly compressed and exits the spiral 4 through an orifice 9 (see FIG. 2).

The spiral 4 is defined by a spiral contour 6 (see FIG. 3), which is preferably milled into a front surface of the axial diffuser insert 5 and communicates with the orifice 9 in the housing via an opening in its circumferential surface, and by a bottom surface 12 of a cutout which is formed in the housing 1 and partially receives the axial diffuser insert 5 (see FIG. 1).

The spiral 4 defined by the milled spiral contour 6 can be optimally dimensioned for the rotor 3, the planned volume flow in the design point of the compressor, and the like. In an advantageous manner, no corresponding casting patterns need be prepared for this purpose. The spiral contour 6 can be formed, for example, by a computer-controlled CNC milling machines in the diffuser insert 5 which is forged from bar material as a semi-finished product.

Through the choice of an inlet insert 8 with corresponding axial diffuser 2, i.e., of a given length and given opening angle, the flow shape in the compressor can be further optimized.

Since the inlet insert 8, diffuser insert 5 and housing 1 are preferably screwed together, costly weld connections can be dispensed with. Further, the housing 1 can be produced from material having poor welding properties, e.g., gray cast iron. In case of damage to the rotor 3, inlet insert 8 or diffuser insert 5, the part in question can be exchanged in a simple manner by removing the screws 10.

A very compact, fluid-tight, low-vibration construction of the compressor results because the axial diffuser insert 5 is partially received in the housing 1.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-18. (canceled)

19. A flow machine, comprising:
a housing;
an axial diffuser arranged in the housing;
a rotor rotatably received in the housing configured to deflect a fluid between an axial direction and a radial direction; and
an axial diffuser insert at least partially received in the housing having one of a spiral contour and a collecting chamber contour formed in the axial diffuser insert,
wherein the axial diffuser insert and the housing define one of a spiral and a collecting chamber.

20. The flow machine according to claim 19, wherein the axial diffuser insert is connected to the housing by a non destructively detachable and reconnectable connector.

21. The flow machine according to claim 19, wherein the spiral contour is formed in the diffuser insert by cutting.

22. The flow machine according to claim 19, wherein at least one of the axial diffuser insert and the housing is constructed as one of a forged part and a shaped part.

23. The flow machine according to claim 19, wherein at least one of the axial diffuser insert and the housing is formed as a cast part.

24. The flow machine according to claim 19, wherein at least one of the axial diffuser insert and the housing is formed as a welded part.

25. The flow machine according to claim 19, wherein the housing is pot-shaped, and the axial diffuser insert is connected in a fluid-tight manner to the housing.

26. The flow machine according to claim 25, wherein the axial diffuser insert has a flange configured to connect the diffuser insert to the housing in the fluid-tight manner.

27. The flow machine according to claim 26, wherein the flange is detachably fastened to the housing by a non destructively detachable and reconnectable connector.

28. The flow machine according to claim 1, wherein the axial diffuser insert and the housing form the axial diffuser.

29. The flow machine according to claim 19, wherein an inlet insert is detachably fastened to the diffuser insert to form the axial diffuser.

30. The flow machine according to claim 19, wherein an orifice that communicates with the spiral is provided in the housing and configured to enable an entrance and exit of the fluid.

31. The flow machine according to claim 19, wherein a bearing for guide vanes configured as one of inlet guide vanes and discharge guide vanes, is formed in one of the housing and the diffuser insert.

32. The flow machine according to claim 19, wherein one of a seal and a sealed bearing for a shaft of the rotor is formed in the housing.

33. The flow machine according to claim 19, wherein the fluid is a gas and the flow machine is one of a radial compressor and a radial expander.

34. The flow machine according to claim 19, wherein the fluid is a liquid and the flow machine is one of a Francis turbine and a scroll casing pump.

35. A method for the production of a flow machine comprising:
inserting a diffuser insert into a housing, the diffuser insert having one of a spiral contour and a collecting chamber contour formed thereon; and
connecting the diffuser insert to the housing with at least one non destructively detachable and reconnectable connection such that the diffuser insert and the housing together define one of a spiral and a connecting chamber.

36. The method according to claim 35, further comprising milling the spiral contour into the diffuser insert.

37. The flow machine according to claim 19, wherein the flow machine is one of a radial compressor, a radial expander, a Francis turbine, a radial pump, and a centrifugal pump

38. The method according to claim 35, wherein the non destructively detachable and reconnectable connection comprises a screw.
